(19) United States
(12) Patent Application Publication
(10) Pub. No.: US 2017/0366785 A1
(43) Pub. Date: Dec. 21, 2017

(54) Hands-Free Headset For Use With Mobile Communication Device

(71) Applicant: Kopin Corporation, Westborough, MA (US)

(72) Inventor: Jeffrey J. Jacobsen, Hollister, CA (US)

(21) Appl. No.: 15/616,343

(22) Filed: Jun. 7, 2017

Related U.S. Application Data
(60) Provisional application No. 62/350,378, filed on Jun. 15, 2016.

(51) Int. Cl. H04N 7/18; G09G 5/00; G06F 3/01; G10L 25/84; G10L 15/20

(52) U.S. Cl. CPC H04N 7/185; H04N 7/181; G10L 25/84; G10L 15/20; G06F 3/012; G09G 5/006; G06F 3/017; G09G 2354/00

(57) ABSTRACT

A hands-free headset, comprising a display module configured to receive visual data and display the visual data on a constituent microdisplay element of the display module. The headset further comprises a mounting bracket configured to releasably attach the headset to a head-worn accoutrement. The mounting bracket may be configured to be fixedly attached to the head-worn accoutrement. The mounting bracket may comprise a first interface for releasably coupling to a second interface on the headset. The headset may comprise a communication interface configured to electrically couple the headset to the a mobile computing device, and to convey the visual data from the mobile computing device to the headset. The headset may utilize the mobile computing device for performing one or both of processing functions and data storage functions.

### RELATED APPLICATION

This claims the benefit of U.S. Provisional Application No. 62/350,378, filed on Jun. 15, 2016. The entire teachings of the above application are incorporated herein by reference.

### BACKGROUND

Mobile computing devices, such as notebook PC's, smart phones, and tablet computing devices, are now common tools used for producing, analyzing, communicating, and consuming data in both business and personal life. Consumers continue to embrace a mobile digital lifestyle as the ease of access to digital information increases with high-speed wireless communications technologies becoming ubiquitous. Popular uses of mobile computing devices include displaying large amounts of high-resolution computer graphics information and video content, often wirelessly streamed to the device. While these devices typically include a display screen, the preferred visual experience of a high-resolution, large format display cannot be easily replicated in such mobile devices because the physical size of such device is limited to promote mobility. Another drawback of the aforementioned device types is that the user interface is hands-dependent, typically requiring a user to enter data or make selections using a keyboard (physical or virtual) or touch-screen display. As a result, consumers are now seeking a hands-free high-quality, portable, color display solution to augment or replace their hands-dependent mobile devices

### SUMMARY OF THE INVENTION

The described embodiments of a hands-free headset (HFH) are directed to a wearable smart device accessory, which may be used with a host device, for example but not limited to smart phones, tablets, notebooks or another mobile device to achieve a true user Hands-Free mobile computing/communication interface providing the user with a noise cancelled (Voice Extraction) user speech and head tracked gesture interface.

In one aspect, the invention is a headset comprising a display module that is configured to receive visual data, and to display the visual data on a constituent microdisplay component of the display module. The headset may further comprise a mounting bracket configured to releasably attach the headset to a head-worn accoutrement. The mounting bracket may be configured to be fixedly attached to the head-worn accoutrement. The mounting bracket may comprise a first interface for releasably coupling to a second interface located on the headset. The headset may further comprise a communication interface configured to electrically couple the headset to a mobile computing device, and to convey the visual data from the mobile computing device to the headset.

In one embodiment, the visual data may be representative of one or more of (i) still image media, (ii) moving image media, (iii) image overlay information and (iv) image annotation information. The headset may further comprise one or more electroacoustic transducers, for example audio speakers, and the communication interface may be further configured to electrically couple audio data from the mobile computing device to the one or more electroacoustic transducers.

The headset may further comprise an image sensor configured to capture viewable manifestations, for example objects in the user's environment, and convey the captured viewable manifestations as video data to the mobile computing device through the communication interface. The image sensor may be at least one of (i) a visible spectrum sensor (e.g., a still-frame or video camera), (ii) an infrared image sensor, (iii) ultraviolet spectrum image sensor, (iv) a sound-based imager, (v) a night-vision imager and (vi) a terahertz imager. The image sensor may comprise a first image sensor directed to an axis substantially parallel to a user's viewing axis, and a second image sensor directed to an axis different from the user's viewing axis by a predetermined angle.

The communication interface may comprise a USB 3.X standard cable, where X is an integer. The mounting bracket may be configured to detach the headset from the display module upon application of a predetermined force to the display module. The headset may utilizes the mobile computing device for performing one or both of a processing function and a data storage function.

The processing function may comprise one or both of user gesture tracking and gesture interpretation. The user gesture tracking may comprise one or more of (i) user head gesture tracking based on one or more user head gestures, (ii) user hand gesture tracking based on one or more user hand gestures detected by an image sensor, and (iii) user body gesture tracking based on one or more user body gestures detected by the image sensor. The headset may combine two or more of user head gestures, user hand gestures and user body gestures to determine user input. The processing function may comprise automatic speech recognition. The processing function may further comprise extraction of voice components from ambient noise components conveyed within received audio data, and performance of automatic speech recognition of the extracted voice componenets.

The headset may further comprise two or more microphones. The mobile computing device may receive audio data from the two or more microphones and extract user voice components from ambient noise components conveyed within the audio data.

The headset may further comprise a display port configured to communicate video data. The headset may further comprise a processing system configured to at least coordinate communications between the headset and the mobile computing device and support operation of the display module.

In another aspect, the invention is a headset comprising a microdisplay, a mounting bracket configured to releasably couple the microdisplay to a head-worn accoutrement, and a communication interface configured to electrically couple the headset to the a mobile computing device. The headset may further comprise an image sensor configured to capture viewable manifestations and convey the captured viewable manifestations as video data to the mobile computing device through the communication interface. The microdisplay may be configured to display visual data provided by the mobile computing device.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A illustrates a user wearing an HFH according to the invention.

FIG. 1B shows the HFH of FIG. 1A alone, apart from a user.

FIG. 2A illustrates three embodiments of an HFH according to the invention.

FIG. 2B shows a detailed view of an embodiment shown in FIG. 2A.

FIGS. 3A and 3B illustrate the magnetic connection on the HFH and the magnetic connection on the HFH bracket.

FIG. 4 illustrates some example adjustment capabilities of one embodiment of an HFH.

FIGS. 5A and 5B illustrate two different views of an example embodiment of an HFH with a display module.

FIG. 6A shows a displayed drainage system with respect to an existing street view.

FIG. 6B shows a displayed ducting system addendum with respect to an existing ducting system.

FIG. 6C shows a displayed instruction image with respect to a maintenance procedure.

FIG. 7 is a diagram of an example internal structure of a processing system that may be used to implement one or more of the embodiments herein.

### DETAILED DESCRIPTION OF THE INVENTION

A description of example embodiments of the invention follows.

The teachings of all patents, published applications and references cited herein are incorporated by reference in their entirety.

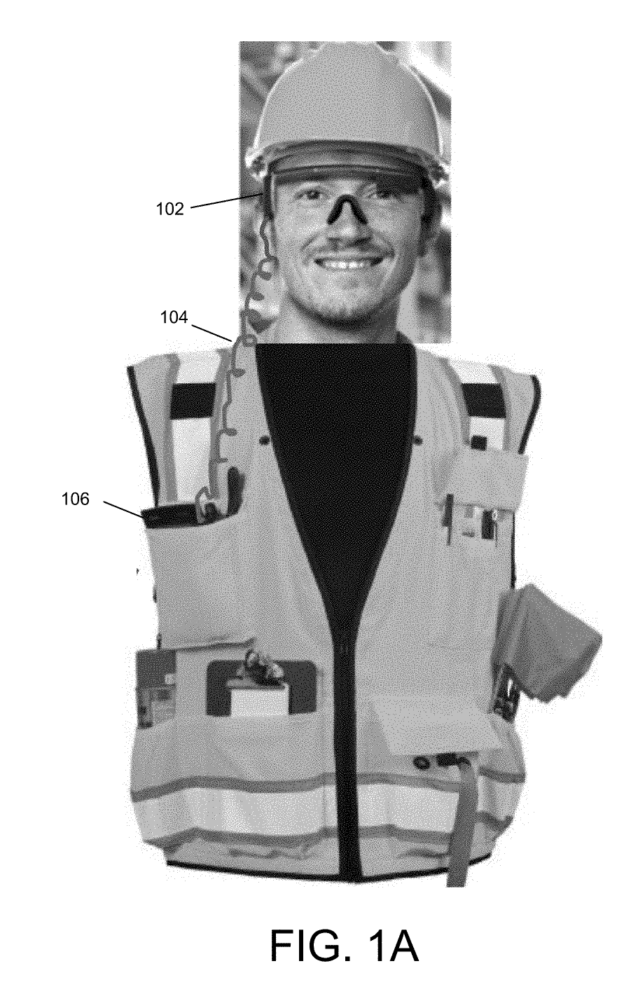

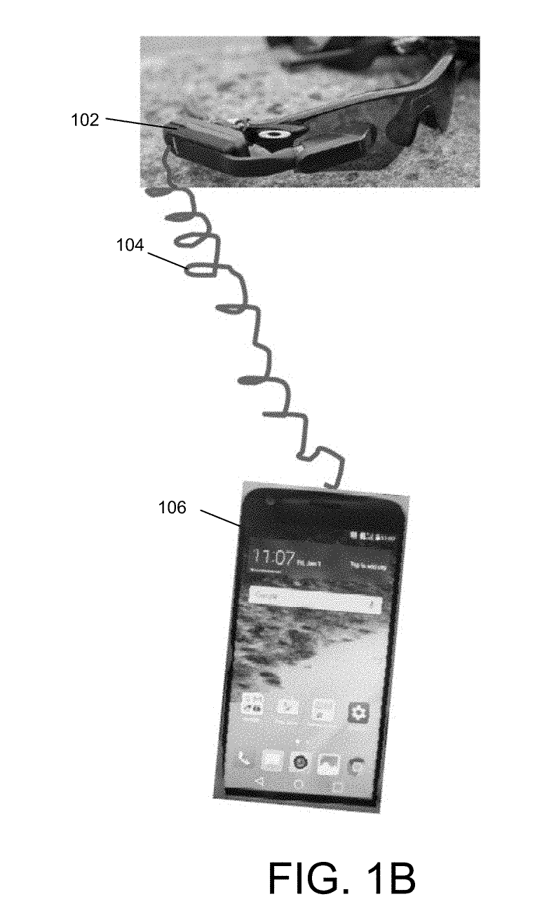

The described embodiments of a hands-free headset (HFH) are directed to a wearable smart device accessory, which may be used with a host device (also referred to herein as mobile computing device or mobile device), for example but not limited to smart phones, tablets, notebooks or another mobile device to achieve a true user Hands-Free mobile computing/communication interface providing the user with a noise cancelled (Voice Extraction) user speech and head tracked gesture interface. FIG. 1A illustrates a user wearing an HFH 102, connected through a high bandwidth interface 104 to a host device 106. FIG. 1B shows the HFH 102, the high bandwidth interface 104 and the host device 106 apart from a user.

Embodiments of the HFH may receive audio data and visual data from the host mobile computing device 106 (smart phone, tablet, notebook or other mobile device), to which the HFH is connected, through the high bandwidth interface 104. As used herein, “audio data” is information that represents or otherwise relates to audible sound. As used herein, “visual data” is information that represents or otherwise relates to viewable manifestations, including but not limited to viewable manifestations based on still image media, moving image media, image overlay information, or image annotation information.

Audio data and visual data delivered to the HFH over the high bandwidth interface is pre-processed and formatted, as the HFH requires, by the host mobile device to which the HFH is connected. The audio data and visual data sent from the host device to the HFH is essentially presentation-ready, requiring very little or no data processing by the HFH. The host mobile device may perform some or all of the necessary image processing and audio processing prior to sending the audio or visual data to the HFH over the high bandwidth interface.

The described embodiments of an HFH may provide a wearable, high resolution microdisplay element (for example, WVGA or higher resolution display formats) supported in a near eye optic configuration, within a user adjustable display module. For more information concerning such microdisplay devices, see co-pending patent applications entitled “Mobile Wireless Display Software Platform for Controlling Other Systems and Devices,” U.S. application Ser. No. 12/348,648 filed Jan. 5, 2009, “Handheld Wireless Display Devices Having High Resolution Display Suitable For Use as a Mobile Internet Device,” PCT International Application No. PCT/US09/38601 filed Mar. 27, 2009, and “Improved Headset Computer,” U.S. Application No. 61/638,419 filed Apr. 25, 2012, each of which are incorporated herein by reference in their entirety.

Although example embodiments of the HFH described herein depict a high resolution microdisplay device as set forth above, alternative embodiments of the HFH may comprise a lower resolution microdisplay element, for example a WQVGA, NVGA or similar display format microdisplay. Such lower resolution embodiments may be applicable to ordinary consumer use, for which particularly high quality images are not necessary, and for which lower complexity and cost are desirable.

The HFH may further comprise one or more image sensors configured to generate visual data corresponding to and descriptive of an object or objects in the environment of the wearer. The image sensors are configured to generate the visual data based on one or more imaging technologies. The image sensors receive propagating energy emitted by, or reflected from, the object(s) in the wearer's environment. While several examples of such imaging technologies are described herein, the examples are intended to be illustrative and not limiting.

An example embodiment may comprise a low power, CMOS high resolution visible spectrum camera (referred to herein as “CMOS camera”) as an image sensor. The example CMOS camera may be two mega-pixel or larger, although lower pixel count CMOS cameras may also be used. The example CMOS camera may be deployed in a separate user adjustable module.

For increased visual information or situational awareness, some HFH embodiments may comprise primary and secondary image sensors that may utilize the same or different imaging technologies. For example, a primary image sensor may comprise a CMOS camera, and one or more secondary image sensors may use other imaging technologies such as infra-red (IR) imaging, ultraviolet (UV) imaging, sound-based imaging (e.g., SONAR or ultrasound imaging), terahertz imaging (using energy radiated at terahertz frequencies), night vision imaging (e.g., image intensification, active illumination and/or thermal vision) or other such imaging techniques. In some embodiments, one or more secondary image sensors, utilizing an imaging technology different from the primary image sensor, may be directed along (or nearly along) the primary image sensor directional axis. In such embodiments, the wearer may alternatively select between, for example, forward view using a visible spectrum image sensor and an infra-red image sensor.

The HFH image sensors may be configured to receive reflections of a propagating phenomenon that is generated by the HFH itself. In other words, the HFH may comprise a propagating phenomenon source, in addition to image sensors that collect the propagating phenomenon reflected from an object. For example, for active sound-based imaging, the HFH may comprise a sound generating device configured to emit sonic energy in a direction corresponding to the directional axis of the sound based image sensor. Or, for a CMOS camera, the HFH may comprise a light source configured to illuminate a region in the wearer's environment along the directional axis of the CMOS camera.

The HFH may comprise sensors configured to receive reflections of a propagating phenomenon generated by an external source that is independent of the HFH. Such propagating phenomenon may include, for example, visible light or terahertz energy reflected by the object being imaged, or IR energy generated by the object being imaged itself. As set forth elsewhere herein, the examples are intended to be illustrative and not limiting.

An example embodiment may include a primary image sensor directed forward (i.e., with respect to the wearer's orientation) and one or more secondary image sensors directed in off-axis orientations (for example, but not limited to, 90 to 180 degrees) with respect to the orientation of the first or primary image sensor. For example, one off-axis image sensor may be directed behind the wearer (i.e., 180 degrees with respect to the primary image sensor) and a second off-axis image sensor may be directed toward the wearer's periphery (i.e, 90 degrees with respect to the primary image sensor). Other off-axis orientations, outside of the example 90 to 180 degrees, may also be used. For some embodiments, the off-axis image sensor(s) may utilize the same imaging technologies as that of the primary image sensor. For other embodiments, the off-axis image sensor(s) may utilize a different imaging technologies than that of the primary image sensor.

The HFH of the described embodiments may include two or more embedded microphones specifically positioned to facilitate enhanced noise cancellation (e.g., voice extraction from ambient noise), and speech recognition, in high ambient noise environments. The two or more microphones may provide audio data to a signal processor that performs noise cancellation operations on the audio data to isolate the wearer's voice from ambient noise and extract the voice from the ambient noise. For more information concerning such microphones and enhanced noise cancellation systems, see co-pending patent applications entitled “Digital Voice Processing Method And System For Headset Computer,” U.S. application Ser. No. 14/318,235, filed Jun. 27, 2014; “Noise Cancelling Microphone Apparatus,” U.S. application Ser. No. 14/181,059, filed Feb. 14, 2014; and “Eye Glasses With Microphone Array,” U.S. application Ser. No. 14/180,994, filed Feb. 14, 2014, each of which are incorporated herein by reference in their entirety.

The HFH of the described embodiments may include an embedded electroacoustic transducer (i.e., audio speaker) as well as a separate embedded audio output connector (e.g., 2.5 mm. 3.5 mm, USB Type C, etc.). The separate embedded audio output connector may facilitate HFH use with an external devices such as an monoaural ear bud, stereo ear buds or noise protection ear covers, which may be employed by the user in excessively noisy ambient environments.

The connection between the HFH and the host device may include a high bandwidth interface 104, as depicted in FIGS. 1A and 1B. Example embodiments of the high bandwidth interface 104 may comprise a USB 3.X (where X is an integer) or newer USB standard cable using USB Type C connectors or Type C connector adapter. Other high bandwidth interface implementations (connectors and conveyance media) known in the art, capable of conveying audio data and visual data, may also be used. In some embodiments, the HFH may comprise a video data port, for example a Video Electronics Standards Association (VESA) DisplayPort, for receiving or conveying video data. For example, the video data port may be used to provide data from a constituent image sensor to an external high-resolution video monitor. Alternatively, the video display port may be used to convey video data from the host device to the HFH.

Embodiments of the HFH 102 may include processing capability that is significantly less than the processing capability of the associated host device 106, and little or no data storage capability (i.e., memory). The HFH 102 may rely on the host device 106 for the bulk of the HFH processing and data storage capabilities.

Embodiments of the HFH may employ a mounting component, such as the bracket described herein, for facilitating releasable attachment to head-worn accoutrements such as eye glasses, safety glasses, goggle frames, or other head-worn accessories. As used herein, terms such as “releasable attachment” or “releasably attached” describe a quick-disconnect attachment scheme or arrangement that provides a secure coupling of the HFH to the head-worn accoutrements, while facilitating a safe and expeditious separation of the HFH and the head-worn accoutrement in the event that a force exceeding a predetermined threshold is applied to the HFH (with respect to the head-worn accoutrement). The predetermined threshold may be a specific value, or may fall within a range of values. The predetermined threshold value may be determined so as to ensure the safety of the wearer, and may be determined based on the particular use scenario of the HFH. For example, the predetermined threshold may be a relatively low value (i.e., causing a disconnect at lower amounts of force, relative to an ordinary use environment) in a hazardous environment, where the wearer has a higher likelihood of injury should the HFH fail to disconnect from the head-worn accoutrement.

In an embodiment, a bracket or other such connection mechanism (referred to herein generally as “bracket”) may facilitate attachment of the HFH to the head-worn accoutrement (e.g., eye glasses, safety glasses, goggle frame or helmet). The bracket may comprise any of various forms and shapes to facilitate easy and safe “quick-disconnect” attachment of the HFH to a head-worn accoutrement. The bracket may facilitate attachment of the HFH to the head-worn accoutrement by one or more securing techniques, including but not limited to magnetic components, elastic bands, elastic clips, plastic latches, fabric hook and loop fasteners, interference fit (i.e., friction fit) systems, or other such attachment mechanisms known in the art.

In general, the bracket may be fixedly attached to the head-worn accoutrement, and may include a bracket connection interface configured to mate with a matching HFH connection interface on the HFH. The two interfaces cooperate, using one or more of the securing techniques described herein, to provide a releasable attachment between the bracket on the head-worn accoutrement and the HFH.

In an example embodiment, the bracket connection interface may comprise a round, magnetic surface cavity, configured to pair with a matching round magnetic protruding connection interface on the HFH (i.e., the HFH connection interface). Although the example embodiments described herein comprise round magnetic connections, other embodiments may include alternative shaped magnetic connections.

The magnetic connection between HFH and the bracket may be strong enough to hold the HFH to the head-worn accoutrement in a user-desired or user-adjusted position during use. The magnetic connection between HFH and the bracket may allow the user to rotate the HFH display module with or without camera sensor module(s) to the desired vertical position during use, and reposition the HFH display module completely out of user's field of view when the HFH display module is not in use.

It should be understood that although the magnetic bracket system is described herein as an example embodiment, the underlying concepts and features described relating to the ability to adjust the position of the HFH, and a safe, quick-disconnect of the HFH from the head-worn accoutrement, also generally apply to the other techniques contemplated for the bracket system.

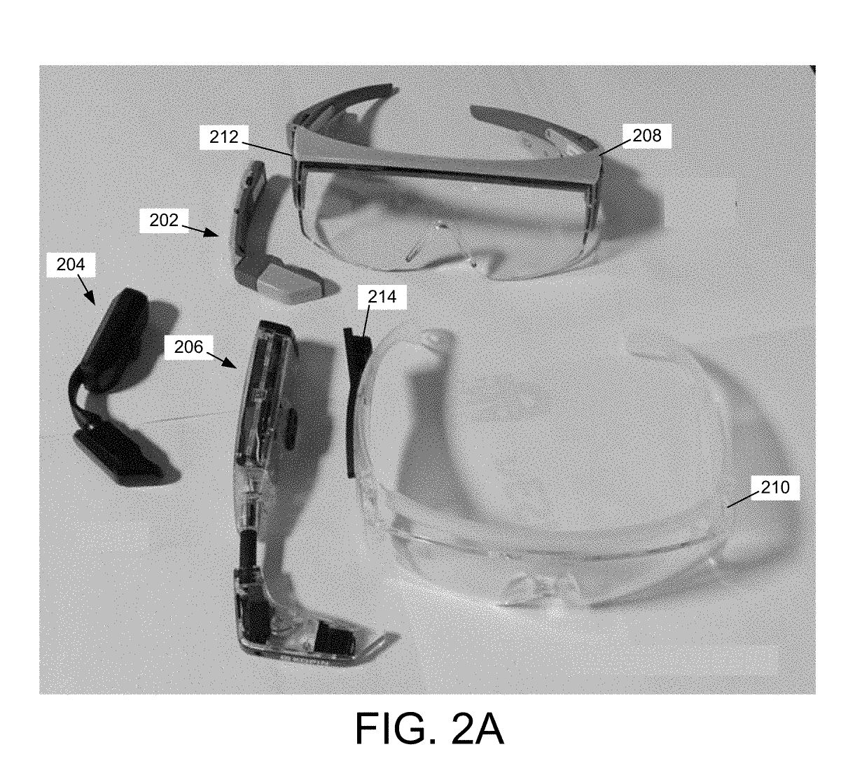

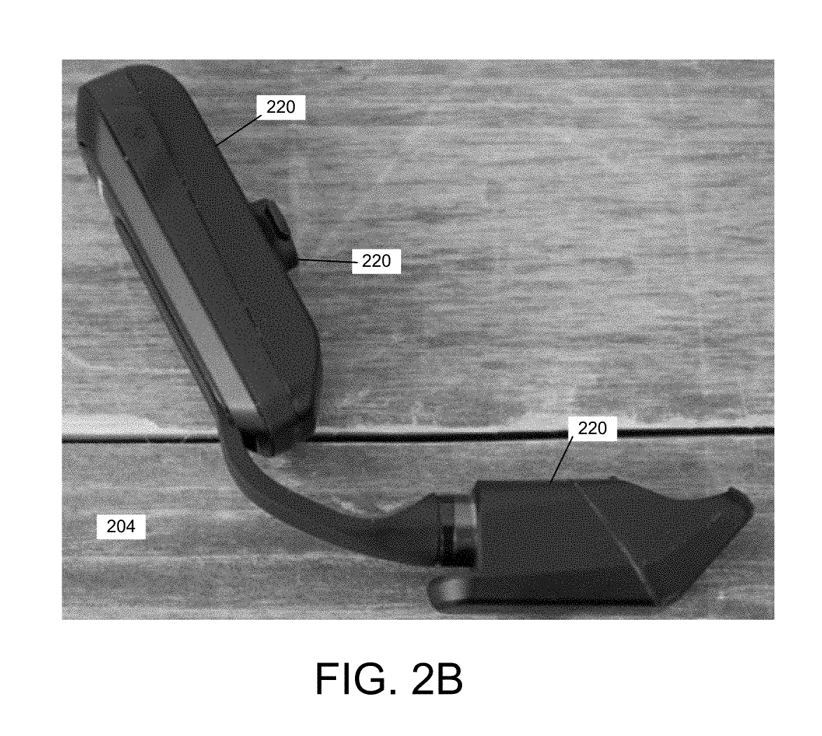

FIG. 2A illustrates a first example HFH embodiment 202, a second example HFH embodiment 204 and a third example HFH embodiment 206, along with two embodiments 208, 210 of head-worn accoutrements with magnetic user adjustable HFH brackets 212, 214, respectively, attached.

FIG. 2B shows a more detailed view of the second embodiment of the HFH 204 of FIG. 2A. The HFH 204 includes main body module 220 and a display module 222. The HFH connection interface 224, configured to cooperate with the bracket connection interface (not shown), may be integrated with the main body module 220.

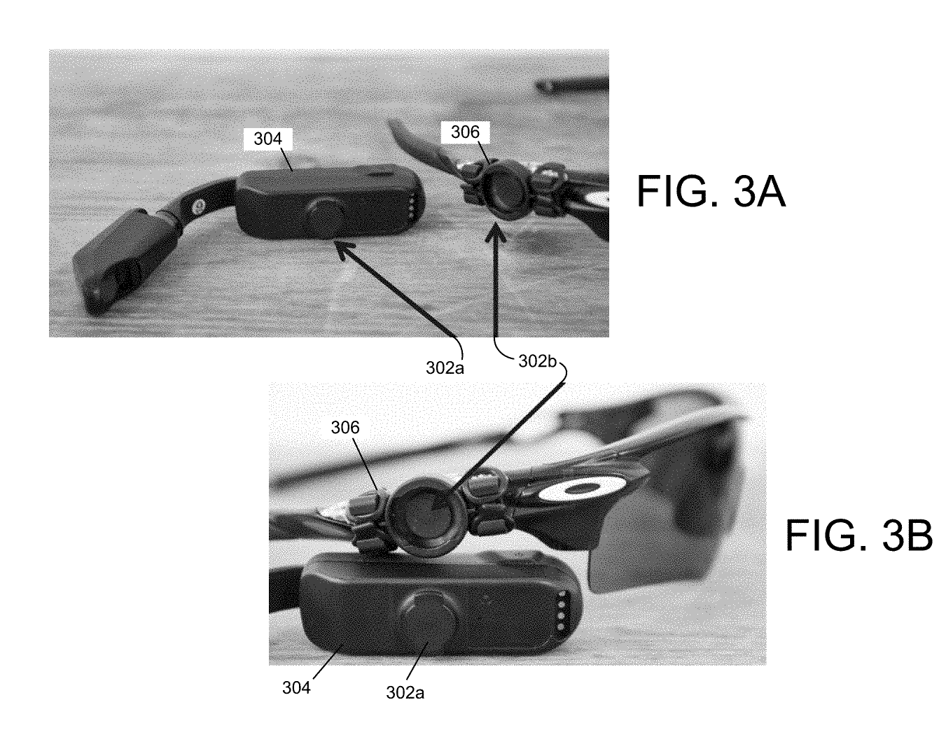

FIGS. 3A and 3B illustrate two views of the magnetic connection 302a on the HFH 304 and the magnetic connection 302b on the HFH bracket 306.

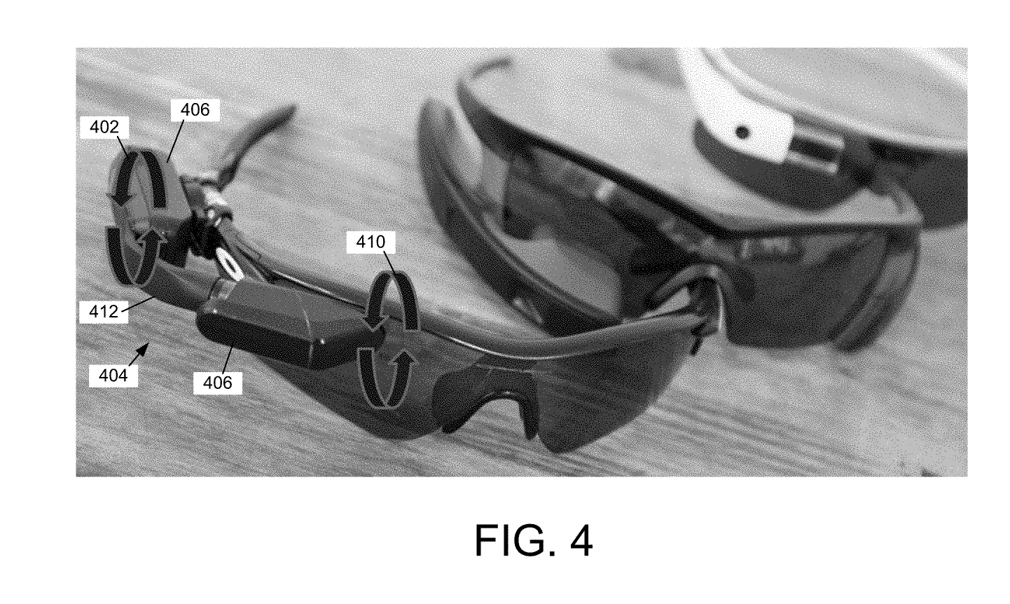

FIG. 4 illustrates some example adjustment capabilities of one embodiment of an HFH. A first adjustment 402 rotates the display module 404 with respect to the HFH body 406, allowing the display element 408 to move into and out of the user's field of view. A second adjustment 410 rotates the display element 408 with respect to the display module support arm 412, allowing the user to establish a direct view of the display element 408. FIG. 4 also illustrates two other embodiments of an HFH associated with different head worn accoutrements.

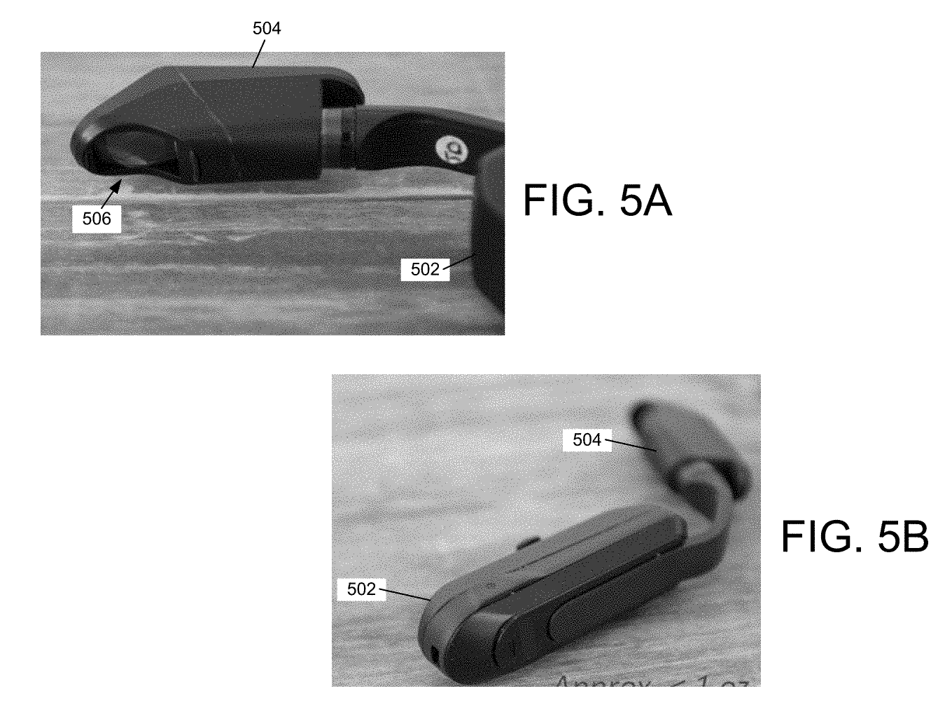

FIGS. 5A and 5B illustrate two different views of an example embodiment of an HFH 502 with a display module 504 and microdisplay 506.

The user adjustable HFH bracket may provide enhanced safety for the user, since the HFH display module can detach from the bracket on the head-worn accoutrement. When a small reasonable, predetermined external force is applied to the USB Type C cable or directly to the HFH device, the bracket interface will separate, freeing the HFH user. The predetermined force is a force that is large enough that the interface will not separate under normal operating conditions, but small enough that the user will not be injured prior to the magnetic interface disengaging. When the HFH device or HFH-to-mobile device interface cable become snagged or caught in the work environment, the environment of use, in or on a piece of machinery, the HFH display module may be configured to safely detach. Once free of an external environment snag or hang-up, the HFH device may be easily magnetically recoupled to the head-worn accoutrement (e.g., eye glass, safety glass or goggle) magnetic bracket and repositioned by the user as needed.

The HFH may include at least one user independently adjustable module. Other embodiments of the HFH may include additional independently adjustable modules for image sensor cameras, audio speakers, or other components such as (i) display module, (ii) CMOS image sensor camera module, (iii) monophonic audio (mono), and/or (iv) stereophonic audio (stereo) electro-acoustic transducer(s) (e.g., audio speaker(s) or microphone(s)), among others. Each module may be releasably attached to a single bracket attached to the head-worn accoutrement, releasably or fixedly attached to the HFH or to other brackets attached to the head-worn accoutrement, or fixedly attached to a bracket attached to the head-worn accoutrement.

The user independently adjustable module(s) attachment and articulation mechanism may include brackets, hinges, and/or ball joints, among other mechanisms, may also include a magnetic interface for ease of user positioning and enhanced repositioning. A magnetic interface may provide minimal wear on adjustment/positioning surfaces with enhanced module position retention during active use.

The HFH utilizes an HFH software application that may run on top of the host computing/communications device (smart phone, tablet, notebook of other mobile device) operational software. The HFH software application running on a host computing and communications device may interpret HFH user spoken or head tracked gesture commands, and combinations thereof, and convert these spoken and head tracked gesture commands into actionable Hands-Free commands, controls and adjustments to the host device and or other devices, systems and/or networks the host computing and communications device maybe cabled to or wirelessly connected to. Examples of systems and method associated with processing head tracked gesture commands may be found in U.S. patent application Ser. No. 14/540,939, filed on Nov. 13, 2014, the entire contents of which are incorporated by reference. The HFR may include components necessary to detect gestures such as head movements. Such components may include accelerometers and other motion detection sensors known in the art. Image sensors of the HFH may be used to detect hand and body movements executed by the user. Such hand and body movements may be used, alone or in conjunction with voice commands and/or head movements to receive user commands.

The HFH software application may provide the HFH user complete or near complete Hands-Free command and control of the host device functions and capabilities. For example, the HFH software application may replace or nearly replace all touch screen or key board commands with Hands-Free spoken commands and/or head tracked gestures, allowing the HFH device user complete freedom of use of both hands as well as to retain all gloves and protective clothing when using the functionality of a smart phone and the extended wireless network and computing servers to which the smart phone may be connected.

HFH host software application may further provide complete or near complete Hands-Free HFH user interface to other software applications running on the host device and/or other software applications running on networked computers, on the internet or in the Digital Cloud.

The HFH may support multiple axis (e.g., 3 axis, 6 axis or 9 axis) head tracking functionality, which may be coupled in real-time or near real-time with sensor readings available on the host device to determine the HFH users location, track movement and provide health and wellness status of the HFH user, locally and/or remotely. The axes may include, for example, pitch, roll and yaw. The multiple axis support may rely on various constituent sensors of the HFH, such as a 3 axis gyroscope, a 3 axis accelerometer, a 3 axis magnetometer, among other such sensors known in the art.

The HFH image and audio sensor data captured by the HFH may be streamed directly to the host mobile device. To view images, video or listen to audio captured by HFH, the data may be pre-processed by the host mobile device and sent directly back to HFH display and speaker(s) for use by the HFH user.

The HFH user may view image sensor data in a different resolution and image frame per second rate from the HFH image sensor data being streamed, stored and/or transmitted by the host device to a remote location. Visual images and streaming video data captured by HFH image sensors may be streamed directly to the host computing/communications device. The HFH software application running on the host device, along with other imaging applications and industry standards present on the host device can vary image storage and/or transmission resolutions from 360 p to 4K and image frame rates from 1 frames per second (fps) to over 300 fps as selected by the HFH user, by someone remotely receiving transmitted visual data from the host device, or simply limited to the image data capabilities of the host device.

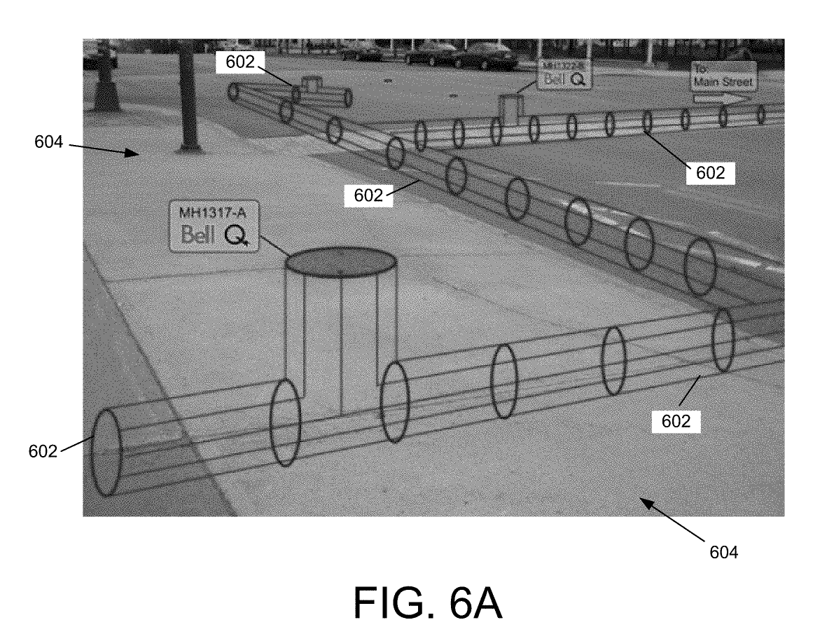

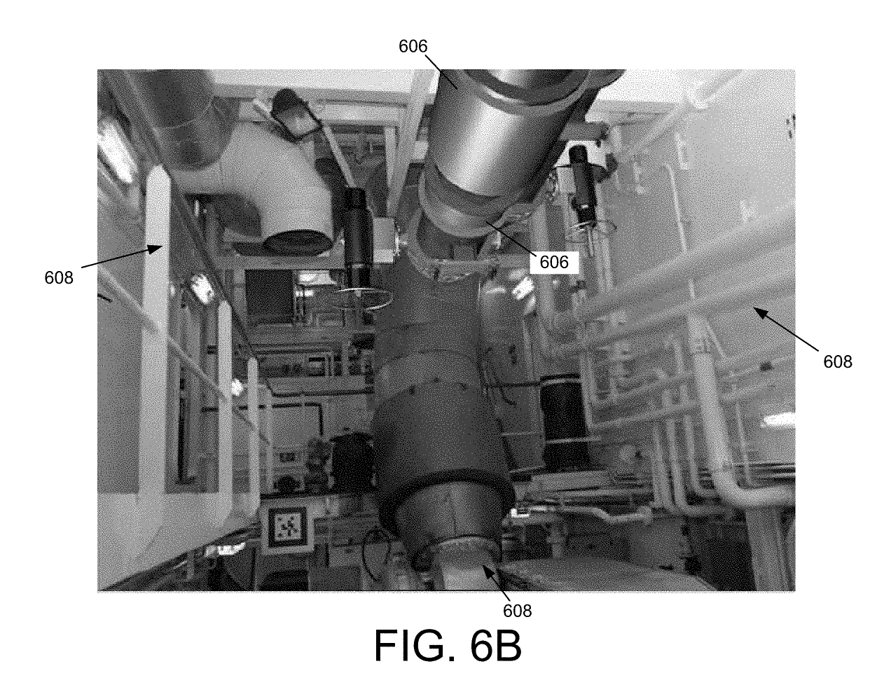

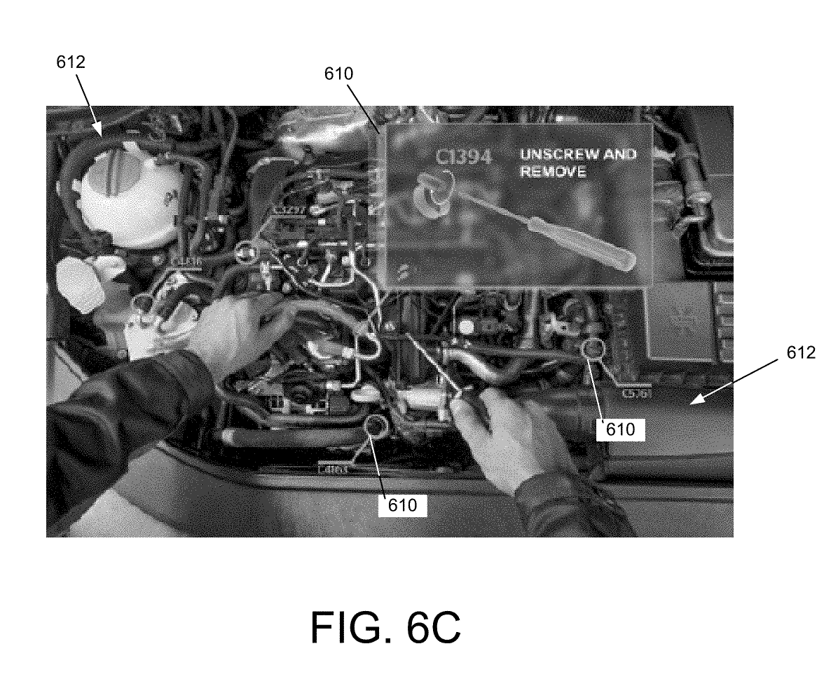

FIGS. 6A, 6B and 6C illustrate example views as may be seen through the described embodiments. FIG. 6A shows a overlay-displayed drainage system 602 with respect to an actual street environment 604 being viewed by the user. FIG. 6B shows a overlay-displayed ducting system addendum 606 with respect to an actual ducting system 608 being viewed by the user. FIG. 6C shows a overlay-displayed instruction image 610 with respect to a user viewing an actual mechanical device 612 and performing a maintenance procedure on the mechanical device 612.

Usage of the HFH of the described embodiments may include enterprise, healthcare, police and military applications, and ordinary consumer use, among others. The specific application may drive specific characteristics of the HFH. For example, an enterprise HFH application may incorporate high-end characteristics such as a high resolution WVGA microdisplay, primary and secondary (off axis) image sensors, and 9 axis head tracking functionality, while an HFH intended for ordinary consumer use may incorporate low-end characteristics such as a lower resolution WQVGA microdisplay, a single image sensor, and 3 axis head tracking functionality.

The HFH interface to a mobile computing device may provide one or more communications capabilities. The communications capabilities may include one or more of (i) cellular communications capability (e.g., 3G to 5G or other communication standards yet to be developed), (ii) wireless local area network capability (e.g., WiFi, Bluetooth), (iii) satellite communications capability, and other communication capabilities that may be supported by the host computing device.

In an example embodiment, the HFH may draw operating power from the host mobile computing device through the HFH interface to the host. Expected battery life of the HFH is expected to be similar to that of the host communications device, i.e., from 12 to 24 hours. Some embodiments may be capable of greater battery life, in the event that the host communications device is tethered to an auxiliary power source.

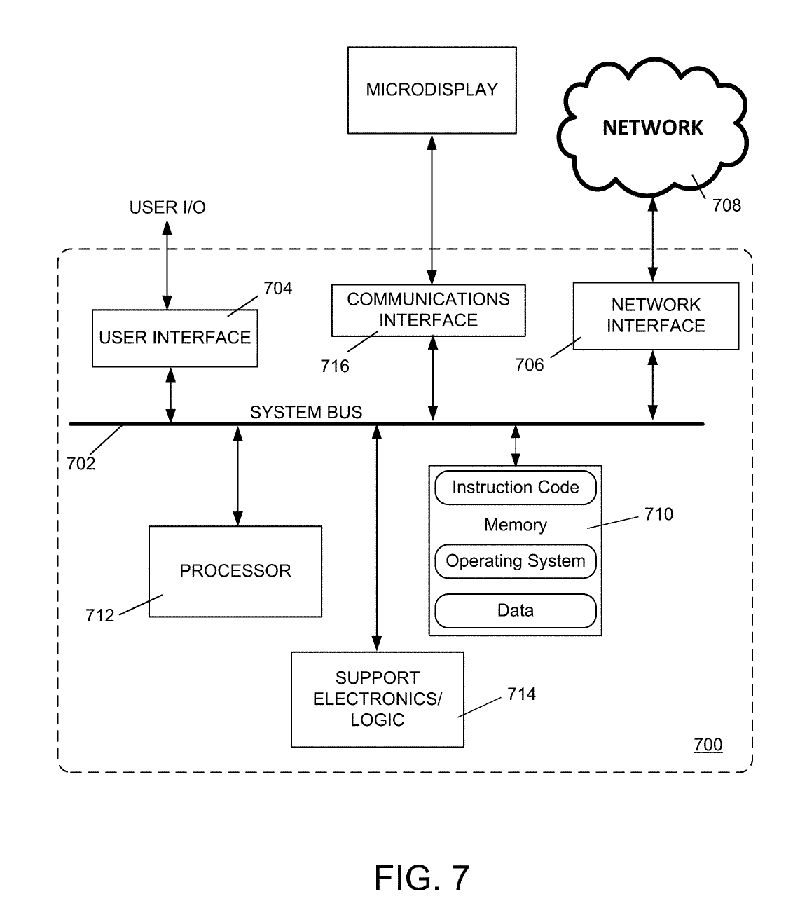

FIG. 7 is a diagram of an example internal structure of a processing system 700 that may be used to implement one or more of the embodiments herein. Each processing system 700 may contain a system bus 702, where a bus is a set of hardware lines used for data transfer among the components of a computer or processing system. The system bus 702 is essentially a shared conduit that connects different components of a processing system (e.g., processor, disk storage, memory, input/output ports, network ports, etc.) that enables the transfer of information between the components.

Attached to the system bus 702 may be a user I/O device interface 704 for connecting various input and output devices (e.g., keyboard, mouse, displays, printers, speakers, etc.) to the processing system 700. A network interface 706 may allow the processing system 700 to connect to various other devices attached to a network 708. Memory 710 may provide volatile and non-volatile storage for information such as computer software instructions used to implement one or more of the embodiments of the present invention described herein, for data generated internally and for data received from sources external to the processing system 700.

A central processor unit 712 may also be attached to the system bus 702 and provide for the execution of computer instructions stored in memory 710. The system may also include support electronics/logic 714, and a communications interface 716. The communications interface may communicate with the microdisplay described herein.

In one embodiment, the information stored in memory 710 may comprise a computer program product, such that the memory 710 may comprise a non-transitory computer-readable medium (e.g., a removable storage medium such as one or more DVD-ROM's, CD-ROM's, diskettes, tapes, etc.) that provides at least a portion of the software instructions for the invention system. The computer program product can be installed by any suitable software installation procedure, as is well known in the art. In another embodiment, at least a portion of the software instructions may also be downloaded over a cable communication and/or wireless connection.

It will be apparent that one or more embodiments described herein may be implemented in many different forms of software and hardware. Software code and/or specialized hardware used to implement embodiments described herein is not limiting of the embodiments of the invention described herein. Thus, the operation and behavior of embodiments are described without reference to specific software code and/or specialized hardware—it being understood that one would be able to design software and/or hardware to implement the embodiments based on the description herein.

Further, certain embodiments of the example embodiments described herein may be implemented as logic that performs one or more functions. This logic may be hardware-based, software-based, or a combination of hardware-based and software-based. Some or all of the logic may be stored on one or more tangible, non-transitory, computer-readable storage media and may include computer-executable instructions that may be executed by a controller or processor. The computer-executable instructions may include instructions that implement one or more embodiments of the invention. The tangible, non-transitory, computer-readable storage media may be volatile or non-volatile and may include, for example, flash memories, dynamic memories, removable disks, and non-removable disks.

While this invention has been particularly shown and described with references to example embodiments thereof, it will be understood by those skilled in the art that various changes in form and details may be made therein without departing from the scope of the invention encompassed by the appended claims.

What is claimed is:

1. A headset, comprising:
a display module configured to receive visual data and display the visual data on a constituent microdisplay component of the display module;
a mounting bracket configured to releasably attach the headset to a head-worn accoutrement, the mounting bracket configured to be fixedly attached to the head-worn accoutrement, and the mounting bracket comprising a first interface for releasably coupling to a second interface on the headset;
a communication interface configured to electrically couple the headset to a mobile computing device, and to convey the visual data from the mobile computing device to the headset.

2. The headset of claim 1, wherein the visual data is representative of one or more of (i) still image media, (ii) moving image media, (iii) image overlay information and (iv) image annotation information.

3. The headset of claim 1, further comprising one or more electroacoustic transducers, and the communication interface is further configured to electrically couple audio data from the mobile computing device to the one or more electroacoustic transducers.

4. The headset of claim 1, further comprising an image sensor configured to capture viewable manifestations and convey the captured viewable manifestations as video data to the mobile computing device through the communication interface.

5. The headset of claim 4, wherein the image sensor is at least one of (i) a visible spectrum camera, (ii) an infrared image sensor, (iii) ultraviolet spectrum image sensor, (iv) a sound-based imager, (v) a night-vision imager and (vi) a terahertz imager.

6. The headset of claim 4, wherein the image sensor comprises a first image sensor directed to an axis substantially parallel to a user's viewing axis, and a second image sensor directed to an axis different from the user's viewing axis by a predetermined angle.

7. The headset of claim 1, wherein the communication interface comprises a USB 3.X standard cable, where X is an integer.

8. The headset of claim 1, wherein the mounting bracket is configured to detach the headset from the display module upon application of a predetermined force to the display module.

9. The headset of claim 1, wherein the headset utilizes the mobile computing device for performing one or both of a processing function and a data storage function.

10. The headset of claim 9, wherein the processing function comprises one or both of user gesture tracking and gesture interpretation.

11. The headset of claim 10, wherein the user gesture tracking comprises one or more of (i) user head gesture tracking based on one or more user head gestures, (ii) user hand gesture tracking based on one or more user hand gestures detected by an image sensor, and (iii) user body gesture tracking based on one or more user body gestures detected by the image sensor.

12. The headset of claim 11, wherein the headset combines two or more of user head gestures, user hand gestures and user body gestures to determine user input.

13. The headset of claim 9, wherein the processing function comprises automatic speech recognition.

14. The headset of claim 13, wherein the processing function further comprises extraction of voice components from ambient noise components conveyed within received audio data, and performance of automatic speech recognition of the extracted voice componenets.

15. The headset of claim 1, further comprising two or more microphones, wherein the mobile computing device receives audio data from the two or more microphones and extracts user voice components from ambient noise components conveyed within the audio data.

16. The headset of claim 1, further comprising a display port configured to communicate video data.

17. The headset of claim 1, further comprising a processing system configured to at least coordinate communications between the headset and the mobile computing device and support operation of the display module.

18. A headset, comprising:
a microdisplay;
a mounting bracket configured to releasably couple the microdisplay to a head-worn accoutrement;
a communication interface configured to electrically couple the headset to the a mobile computing device.

19. The headset of claim 18, further comprising an image sensor configured to capture viewable manifestations and convey the captured viewable manifestations as video data to the mobile computing device through the communication interface.

20. The headset of claim 18, wherein the microdisplay is configured to display visual data provided by the mobile computing device.
